(19) United States
(12) Patent Application Publication
(10) Pub. No.: US 2023/0406072 A1
(43) Pub. Date: Dec. 21, 2023

(54) Refrigeration Circuit, and Heat Management System and Motor Vehicle Having a Refrigeration Circuit of This Type

(71) Applicant: Bayerische Motoren Werke Aktiengesellschaft, Muenchen (DE)

(72) Inventors: Christian ALLGAEUER, Muenchen (DE); Torsten FRANK, Vatterstetten (DE); Oliver HORN, Muenchen (DE); Irina LADE, Neufahrn bei Freising (DE); Patrick MARINELL, Muenchen (DE); Markus MOSER, Oberschleissheim (DE)

(21) Appl. No.: 18/037,042

(22) PCT Filed: Jun. 9, 2022
(86) PCT No.: PCT/EP2022/065709

§ 371 Date: May 15, 2023

(30) Foreign Application Priority Data
Jul. 9, 2021 (DE) 10 2021 117 787.1

(51) Int. Cl. B60H 1/32; F25B 41/42; F25B 41/20

(52) U.S. Cl. CPC B60H 1/32284; B60H 1/323; F25B 41/42; F25B 41/20; B60H 2001/3291; F25B 2600/2501

(57) ABSTRACT

A refrigeration circuit for a motor vehicle includes a refrigerant compressor, a condenser for exchanging heat with a cooling circuit, a chiller for exchanging heat with the cooling circuit, and an evaporator for temperature control of air in an air-conditioning device. The evaporator being in parallel with the chiller, and, in a main circuit, the refrigerant compressor, the condenser, and the parallel circuit of chiller and evaporator being connected in series. The circuit also includes a return line that branches off from the main circuit on a high-pressure side of the refrigerant compressor and leads into the main circuit on a low-pressure side of the refrigerant compressor, and a valve circuit to block and release flow through the return line.

### FIELD

The invention relates to a refrigeration circuit, in particular for electrified motor vehicles, i.e. for at least temporarily electrically driven motor vehicles. Furthermore, the invention relates to a heat management system having a refrigeration circuit of this type and to a motor vehicle having a refrigeration circuit of this type.

### BACKGROUND AND SUMMARY

Heat management systems with refrigeration circuits are known from the prior art, e.g. DE 10 2019 107 191 A1 or DE 10 2019 120 229 A1. In such systems, however, electric heaters are required for heating the vehicle occupant compartment in order to enable sufficiently rapid heating in the case of cold ambient conditions and with little available waste heat. Such electric heaters consume electrical energy, which has a negative effect on the energy efficiency of the electrified motor vehicle.

It is therefore an object of the present invention to at least partially eliminate the disadvantages stated above. This object is achieved by a refrigeration circuit as claimed in claim 1, a heat management system as claimed in claim 9, a motor vehicle as claimed in claim 10, a method as claimed in claim 11 and a method as claimed in claim 12. Advantageous developments of the invention form the subject matter of the dependent claims.

According to one exemplary embodiment of the invention, a refrigeration circuit, more particularly for a motor vehicle, is provided, having a refrigerant compressor, a condenser, in particular a water-cooled condenser, for exchanging heat with a cooling circuit; a chiller for exchanging heat with the cooling circuit; an evaporator for controlling the temperature, in particular cooling, air in an air-conditioning device, wherein the evaporator is arranged in parallel with the chiller, wherein the refrigerant compressor, the condenser and the parallel circuit comprising the chiller and the evaporator are connected in series in a main circuit, in particular are connected in series in this sequence in the flow direction of the refrigerant; a return line, which branches off from the main circuit on a high-pressure side of the refrigerant compressor and leads into the main circuit on a low-pressure side of the refrigerant compressor, and a valve circuit, which is designed at least to block and release flow through the return line. In particular, the valve circuit is designed to block, partially release and completely release flow through the return line. In this case, the valve circuit functions as an expansion member in a state in which it partially releases the flow through the return line.

This exemplary embodiment offers the advantage that a short circuit is created by the return line, via which thermal energy is supplied by the drive of the refrigerant compressor, while little or no thermal energy is dissipated in the main circuit, ensuring that the refrigeration circuit starts up more quickly and can provide a higher heating power in a shorter time. As a result of this faster start-up of the refrigeration circuit, it may be possible to dispense with an electric heater or to use an electric heater with lower power.

In addition to the faster start-up, the exemplary embodiment has, above all, the advantage that the electric power fed into the refrigeration circuit via the refrigerant compressor can be used for heating at the heating condenser and thus the refrigeration circuit can be operated without a further, expensive electric heater in the event of deficiencies in heat sources whose heat is fed into the refrigeration circuit via the chiller in the prior art.

In the context of this invention, the high-pressure side of the refrigerant compressor is defined, in particular, as the region in the refrigeration circuit which extends from an outlet of the refrigerant compressor in the flow direction of the refrigerant to expansion members of the refrigeration circuit, these expansion members being, in particular, an evaporator valve, which is connected upstream of the evaporator, and a chiller valve, which is connected upstream of the chiller.

In the context of this invention, the low-pressure side of the refrigerant compressor is defined, in particular, as the region in the refrigeration circuit which extends from an inlet of the refrigerant compressor counter to the direction of flow of the refrigerant to expansion members of the refrigeration circuit, these expansion members being, in particular, the evaporator valve, which is connected upstream of the evaporator, and the chiller valve, which is connected upstream of the chiller.

In particular, the evaporator is arranged in an air duct via which air can be supplied to a vehicle interior, and therefore the evaporator is designed to control the temperature of the air which can be supplied to the vehicle interior, in particular to cool it. In particular, the return line branches off from the main circuit downstream of the refrigerant compressor and upstream of the condenser.

According to a further exemplary embodiment of the invention, a refrigeration circuit is provided, furthermore having a heating condenser for controlling the temperature of air in the air-conditioning device, wherein the refrigerant compressor, the heating condenser, the condenser and the parallel circuit comprising the chiller and the evaporator are connected in series, in particular are connected in series in this sequence in the direction of flow of the refrigerant. By means of this heating condenser, the thermal energy in the refrigeration circuit, in particular the thermal energy generated by the refrigerant compressor, can be used directly for heating air which is to be supplied to the occupant compartment.

In particular, the heating condenser is arranged in an air duct via which air can be supplied to a vehicle interior, and therefore the heating condenser is designed to control the temperature of the air which can be supplied to the vehicle interior, in particular to heat it. In particular, the return line branches off from the main circuit downstream of the refrigerant compressor and upstream of the heating condenser.

According to a further exemplary embodiment of the invention, the valve circuit is additionally designed at least to block and release flow through the main circuit, in particular to block, partially release and completely release it. In this case, in a state in which it partially releases the flow through the main circuit, the valve circuit functions as an expansion member in order in this way to lower the high pressure and thus the temperature level in the heating condenser, thereby enabling the power output in the heating condenser to be throttled.

According to a further exemplary embodiment of the invention, the valve circuit has a single valve, for example a 3/2-way valve, which is arranged at the branch of the return line from the main circuit, or the valve circuit has a first valve, which is arranged in the main circuit, downstream of the branch of the return line and is designed at least to block and release flow through the main circuit (in particular to block, partially release and completely release it), and a second valve, which is arranged in the return line and is designed at least to block and release flow through the return line (in particular to block, partially release and completely release it). In particular, the first valve is arranged in the main circuit upstream of the condenser and upstream of the heating condenser. In particular, the single valve or the first and/or second valve is a proportional valve.

One advantage of controlling the flow through the main circuit by means of the valve circuit or by means of the first valve is that, during operation of the refrigerant short circuit, i.e. when there is flow through the return line, partial opening of the first valve or partial flow through the main circuit ensures that a final compression pressure downstream of the refrigerant compressor reaches particularly high values, and this compressor therefore absorbs a particularly high electric power and feeds it into the refrigeration circuit system, while the condensation pressure in the heating condenser can be set to a level which is just sufficient and in this way a maximum possible enthalpy difference at the heating condenser is achieved. In this way, the heating power can be maximized.

According to a further exemplary embodiment of the invention, the refrigeration circuit is further provided with a chiller valve, which is arranged upstream of the chiller and, in particular, downstream of the condenser, and which is designed to block and release throughflow. In particular, the chiller valve is designed to block, partially release and completely release throughflow. In this case, the chiller valve functions as an expansion member in a state in which it partially releases throughflow. For example, the chiller valve is a proportional valve. The chiller valve can be used to control the chiller.

According to a further exemplary embodiment of the invention, the refrigeration circuit is further provided with an evaporator valve, which is arranged upstream of the evaporator, and in particular downstream of the condenser, and which is designed to block and release throughflow. In particular, the evaporator valve is designed to block, partially release and completely release throughflow. In this case, the evaporator valve functions as an expansion member in a state in which it partially releases throughflow. For example, the evaporator valve is a proportional valve. The evaporator valve can be used to control the evaporator.

According to a further exemplary embodiment of the invention, the refrigeration circuit is furthermore provided with an inner heat exchanger, which connects the high-pressure side of the refrigerant compressor to the low-pressure side of the refrigerant compressor in a manner which transfers heat and is fluidically separate. With this inner heat exchanger, it is possible to control the efficiency and power of the refrigeration circuit.

According to a further exemplary embodiment of the invention, a bypass line having a bypass valve is provided, which bypass line connects a high-pressure side of the refrigerant compressor to a low-pressure side of the refrigerant compressor and bypasses at least the chiller and the evaporator, wherein the bypass valve is designed at least to block and release throughflow.

In particular, the bypass valve is designed to block, partially release and completely release throughflow. In this case, this bypass valve functions as an expansion member in a state in which it partially releases throughflow. For example, the bypass valve is a proportional valve.

According to a further exemplary embodiment of the invention, the refrigeration circuit is furthermore provided with a liquid collector. This can be arranged on the low-pressure side of the refrigerant compressor, for example. In this arrangement, the liquid collector ensures that gaseous components are reliably removed from the refrigerant, and therefore, as far as possible, the refrigerant is then present only in gaseous form at the inlet of the refrigerant compressor. The liquid collector can likewise be arranged on the high-pressure side of the refrigerant compressor.

Overall, in normal refrigeration circuit operation, the liquid collector has the functions of buffering refrigerant mass for compensation of the circulating refrigerant quantity in various operating states of the refrigeration circuit, of separating gas and residual liquid of the incoming evaporated refrigerant, of collecting the liquid and of removing the gaseous refrigerant.

In addition, the present invention provides a heat management system having a refrigeration circuit of this type, a cooling circuit and an air-conditioning device.

Furthermore, the present invention provides a motor vehicle having a refrigeration circuit of this type or a heat management system of this type.

In addition, the invention provides a method for controlling a refrigeration circuit of this type, wherein the refrigeration circuit is operated in an operating state in which the valve circuit blocks flow through the main circuit and releases flow through the return line, thus preventing heat dissipation from the refrigeration circuit via the heating condenser and the condenser. As already described above, this operating state makes possible a particularly rapid start-up of the refrigeration circuit since heat emission is substantially prevented.

In addition, the invention provides a method for controlling a refrigeration circuit of this type, wherein the refrigeration circuit is operated in an operating state in which the valve circuit releases flow through the main circuit and releases flow through the return line. As a result of this operating state, heat can already be emitted, in particular via the heating condenser, despite the rapid start-up of the refrigeration circuit.

According to a further exemplary embodiment of the method, flow through the main circuit via the valve circuit, in particular via a degree of opening of the first valve, is set in accordance with a heating power requirement in a vehicle occupant compartment.

According to a further exemplary embodiment of the method, the refrigeration circuit is operated in an operating state in which a pressure level on the low-pressure side of the refrigerant compressor is set in such a way via control of the valve circuit, the evaporator valve, the chiller valve and the refrigerant compressor that the refrigerant compressor is operated at its continuous power maximum.

A preferred exemplary embodiment of the present invention is described below with reference to the accompanying drawings.

### BRIEF DESCRIPTION OF THE DRAWINGS

FIG. 1 schematically shows a refrigeration circuit according to a first exemplary embodiment of the invention;

FIG. 2 schematically shows a refrigeration circuit according to a second exemplary embodiment of the invention;

FIG. 3 schematically shows a refrigeration circuit according to a third exemplary embodiment of the invention;

FIG. 4 schematically shows a refrigeration circuit according to a fourth exemplary embodiment of the invention;

FIG. 5 schematically shows a refrigeration circuit according to a fifth exemplary embodiment of the invention;

FIG. 6 schematically shows a refrigeration circuit according to a sixth exemplary embodiment of the invention;

FIG. 7 schematically shows a refrigeration circuit according to a seventh exemplary embodiment of the invention;

FIG. 8 schematically shows a refrigeration circuit according to an eighth exemplary embodiment of the invention;

FIG. 9 schematically shows a refrigeration circuit according to a ninth exemplary embodiment of the invention; and

FIG. 10 schematically shows a refrigeration circuit according to a tenth exemplary embodiment of the invention.

### DETAILED DESCRIPTION

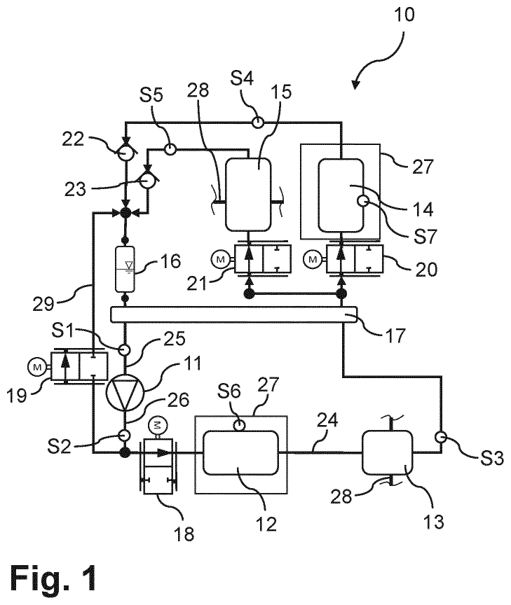

FIG. 1 schematically shows a refrigeration circuit 10 according to a first exemplary embodiment of the present disclosure. The refrigeration circuit 10 has a refrigerant compressor 11, a heating condenser 12, a condenser 13, in particular this is a water-cooled condenser, an air conditioning evaporator or evaporator 14, a chiller 15, a liquid collector 16 and an inner heat exchanger 17. In addition, a valve circuit having a first valve 18 and a second valve 19 is provided, as illustrated in FIG. 1. Alternatively, the valve circuit can also be implemented by a single valve, for example a 3/2-way valve having one inlet and two outlets. Furthermore, an evaporator valve 20 and a chiller valve 21 are provided in the refrigeration circuit 10. This valve circuit or the valves 18 and 19 as well as the valves 20 and 21 are designed to block or release throughflow, in particular to block, partially release or completely release it. Furthermore, the valve circuit and the valves function as expansion members in the partially open state.

The evaporator 14 and the chiller 15 are connected in parallel with one another. To be more precise, a series circuit comprising the evaporator valve 20, the evaporator 14 and a check valve 22 or one-way valve is arranged in parallel with a series circuit comprising the chiller valve 21, the chiller 15 and a check valve 23 or one-way valve. In the respective series circuit, the said elements are arranged in the stated sequence, in particular in the direction of flow.

A refrigerant, for example R134a, R1234yf, R744, R290 or the like, circulates in the refrigeration circuit 10, in particular through the components of the refrigeration circuit 10.

The refrigeration circuit 10 forms a main circuit 24, in which the refrigerant compressor 11, the first valve 18 (or the valve circuit), the heating condenser 12, the condenser 13, the parallel circuit comprising the evaporator 14 and the chiller 15 as well as the liquid collector 16 are connected in series. In particular, the aforementioned components are connected in series in this sequence, as seen in the flow direction of the refrigerant. However, a different sequence is also possible, for example the heating condenser 12 and the condenser 13 could be interchanged with respect to the sequence.

The refrigerant compressor 11 is, in particular, an electrically driven refrigerant compressor and has an inlet side or low-pressure side 25 and an outlet side or high-pressure side 26.

The heating condenser 12 is, in particular, an air-liquid heat exchanger through which the refrigerant can flow and which is arranged in an air-conditioning device 27. More precisely, the heating condenser 12 is arranged in an air duct of the air-conditioning device 27, via which duct air can be supplied to a vehicle occupant compartment, thus enabling this air to be temperature-controlled, in particular heated, by means of the heating condenser 12.

The evaporator 14 is, in particular, an air-liquid heat exchanger, through which the refrigerant can flow and which is likewise arranged in the air-conditioning device 27. More precisely, the evaporator 14, together with the heating condenser 12, is arranged in the air duct of the air-conditioning device 27, via which duct air or recirculated air can be supplied to the vehicle occupant compartment, thus enabling this air to be temperature-controlled, in particular cooled, by means of the evaporator 14.

The condenser 13 can be flowed through by the refrigerant of the main circuit 24 and is fluidically separated therefrom and, in heat exchange therewith, can be flowed through by a coolant of a cooling circuit 28. The cooling circuit 28 is not described more specifically in the context of this present disclosure, but it can be a cooling circuit, as known, for example, from DE 10 2019 107 191 A1 or DE 10 2019 120 229 A1.

The chiller 15 is a heat exchanger which transfers thermal energy between the refrigerant of the refrigeration circuit 10 and the coolant of the cooling circuit 28. For this purpose, the refrigerant and the coolant flow through the chiller 15 in a manner fluidically separated from one another and in heat exchange with one another.

To adjust the flow through the evaporator 14, to adjust the expansion of the coolant upstream of the evaporator 14 and thus to adjust its cooling capacity, the evaporator valve 20 is connected upstream thereof. To adjust the flow through the chiller 15 and to adjust the expansion of the coolant upstream of the chiller 15, the chiller valve 21 is connected upstream thereof. In this case, the evaporator valve 20 and the chiller valve 21 function as expansion members in the partially open state. These can be, for example, self-regulating and electrically controllable expansion members.

The refrigeration circuit 10 furthermore has the inner heat exchanger 17, which has two chambers that can be flowed through in thermal contact but are fluidically separated from one another. In the main circuit 24, one chamber is in this case arranged between the condenser 13 and the parallel circuit comprising the evaporator 14 and the chiller 15, and the other chamber is arranged between the liquid collector 16 and the refrigerant compressor 11. The chambers are preferably flowed through in opposite directions and thus form a countercurrent heat exchanger. Thus, the inner heat exchanger 17 is flowed through in one chamber, by the gaseous, low-pressure refrigerant coming from the liquid collector 16 and, in the other chamber, by the high-pressure liquid refrigerant coming from the condenser 13. Thermal energy is removed from the liquid refrigerant by the inner heat exchanger 17, leading to further cooling of the refrigerant. This energy is supplied to the predominantly gaseous refrigerant, with the result that an even higher proportion evaporates and is present in gaseous form. This serves to increase the capacity and efficiency of the refrigeration circuit 10. However, the inner heat exchanger 17 is not absolutely necessary for the operation of the refrigeration circuit 10.

To control the refrigeration circuit 10, a plurality of sensors S1 to S7 is provided, sensors S1 to S5 each being a sensor or a combination of sensors for measuring a refrigerant temperature and a refrigerant pressure. The sensors S6 and S7 are temperature sensors. Sensor S1 is provided on an inlet side and sensor S2 is provided on an outlet side of the refrigerant compressor 11. Sensor S3 is arranged downstream of the condenser 13, in particular between the condenser 13 and the parallel circuit comprising the evaporator 14 and the chiller 15, more precisely between the condenser 13 and the inner heat exchanger 17. The positioning of sensor S3 downstream of the condenser 13 is therefore advantageous since it is possible here to determine the supercooling after condensation, which can expediently be further processed in the open-loop and closed-loop control system. However, sensor S3 can also be arranged at any other point between the first valve 18 and the parallel circuit comprising the evaporator 14 and the chiller 15 (in particular upstream of the evaporator valve 20 and the chiller valve 21) since the same refrigerant pressure prevails everywhere in this section. However, using such an alternative arrangement involves forgoing the information on the supercooling downstream of the condenser 13. Sensor S4 is provided on an outlet side of the evaporator 14, in particular upstream of check valve 22. Sensor S5 is provided on an outlet side of the chiller 15, in particular upstream of check valve 23. Sensor S6 is arranged on the heating condenser 12 in order to detect its temperature, and sensor S7 is arranged on the evaporator 14 in order to detect its temperature.

According to the present disclosure, a return line 29 is provided which branches off from the main circuit 24 on the high-pressure side 26 of the refrigerant compressor 11, in particular between the compressor 11 and the first valve 18, and leads into the main circuit 24 again on the low-pressure side 25, in particular between the parallel circuit comprising the evaporator 14 and the chiller 15 and the liquid collector 16. In the event that the valve circuit is formed from a single valve, then this valve would be provided at the branch of the return line 29 from the main circuit 24.

In an operating state in which the first valve 18 blocks throughflow and the second valve 19 releases throughflow, a short circuit is formed via the return line 29, which circuit has only the refrigerant compressor 11, the return line 29 including the second valve 19, the liquid collector 16 and the inner heat exchanger 17. In this operating state, refrigerant is circulated only in this short circuit and is not circulated in the main circuit 24 owing to the blocking of the first valve 18.

Via this short circuit, refrigerant in the form of hot gas is removed from the high-pressure side 26, expanded to a low-pressure level by the second valve 19 and fed to the low-pressure side 25. As a result of this refrigerant hot gas injection on the low-pressure side of the refrigerant compressor 11, a very rapid start-up of the refrigeration circuit 10 can be achieved, in particular in a start-up phase, because thermal energy is supplied via the refrigerant compressor to the refrigerant, which then circulates back to the inlet of the refrigerant compressor 11 and is again supplied with thermal energy, without this thermal energy being removed from the refrigerant again to any significant degree.

The refrigeration circuit 10 can furthermore be operated in an operating state in which the first valve 18 is partially or completely open and the second valve 19 blocks throughflow, with the result that the main circuit 24 is in operation (refrigerant circulates) and the short circuit is not in operation (refrigerant does not circulate). This operating state is suitable, for example, when the refrigeration circuit power requirement (for example for heating the vehicle occupant compartment) is not so high, and therefore the additional thermal energy described above is not required by the short circuit.

Furthermore, the refrigeration circuit 10 can be operated in an operating state in which the first valve 18 is partially or completely open and the second valve 19 is likewise partially or completely open, with the result that both the short circuit and the main circuit 24 are in operation. This operating state is suitable, for example, after a start-up phase, a high refrigeration circuit capacity (for example for heating the vehicle occupant compartment) still being required in continuous operation.

When the short circuit is in operation, as described above, thermal energy is supplied to the refrigeration circuit 10 by the driving of the refrigerant compressor 11. It is then possible for this thermal energy to be output subsequently—if initially only the short circuit is operated—or in parallel—if the short circuit and the main circuit 24 are operated simultaneously to the air-conditioning device 27 at the heating condenser 12, thus ensuring that a higher heating power can be provided more quickly.

In other words, when the refrigeration circuit 11 is started, heat emission at the heating condenser 12 and/or at the condenser 13 is avoided by blocking flow through the first valve 18, thereby enabling the refrigeration circuit 10 to be started up more quickly.

In a heating mode, in which both the main circuit 24 and the short circuit are in operation, an optimum intermediate pressure can be set at the heating condenser 12 by means of the first valve 18, thus making it possible to set a refrigerant condensation temperature for heat output from the heating condenser 12 to the air-conditioning device 27, more precisely to the air to be heated, in accordance with requirements, and to set a heat output at the condenser 13 in accordance with requirements.

By means of the control of the first and second valves 18, 19, the evaporator valve 20 and the chiller valve 21 as well as control of the refrigerant compressor 11, it is possible, in a heat pump mode, to set a low-pressure level in such a way that, in addition to the heat absorption at the chiller 15, a heating power can be increased by admixing hot gas to the low-pressure side 25.

Furthermore, during operation of the short circuit, the low-pressure level can be set in such a way, by control of the first valve 18, the second valve 19, the chiller valve 21 and control of the refrigerant compressor 11, that a resulting refrigerant saturation temperature or refrigerant density is at a maximum so that the refrigerant compressor 11 is loaded to the maximum. Consequently, the resulting refrigerant saturation temperature is generally above the air or coolant temperature at the evaporator 14 or chiller 15.

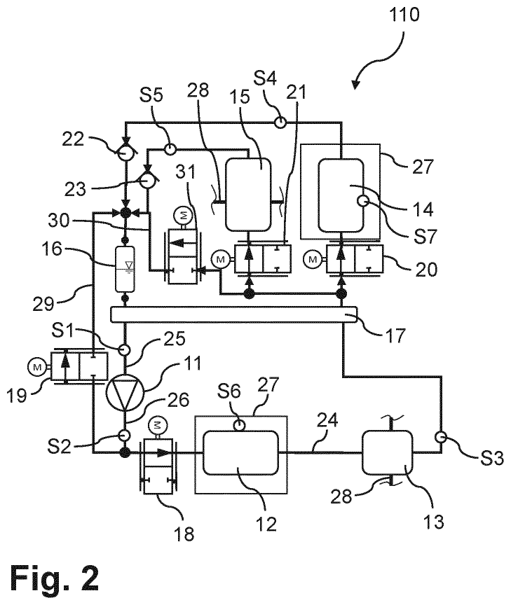

FIG. 2 schematically shows a refrigeration circuit 110 according to a second exemplary embodiment of the present disclosure. Refrigeration circuit 110 differs from refrigeration circuit 10 only in that a bypass line 30 is provided for the parallel connection of the evaporator 14 and the chiller 15, said bypass line extending parallel to the series circuit comprising the evaporator valve 20, the evaporator 14 and check valve 22 and parallel to the series circuit comprising the chiller valve 21, the chiller 15 and check valve 23. Arranged in the bypass line 30 is a bypass valve 31, which is designed to block or release throughflow, in particular to block, partially release or completely release it.

In particular, the bypass valve 31 is controlled in such a way that it completely or partially releases throughflow while the short circuit and the main circuit 24 are in operation. Flow through the chiller 15 and the evaporator 14 is prevented by shutting them off on the high-pressure side by means of the evaporator valve 20 and the chiller valve 21 and on the low-pressure side by means of the check valves 22 and 23. A situation where, during operation of the short circuit, a lower pressure is applied to the outlets of the chiller 15 and the evaporator 14 than to their inlets via the check valves 22 and 23, allowing refrigerant to be drawn into the chiller 15 and the evaporator 14, is avoided.

It is thus possible, in the first and second exemplary embodiments, to provide an operating state in which a coolant flow through the chiller 15 is blocked by closing the evaporator valve 20 and the chiller valve 21 at the evaporator 14, with the result that heat dissipation at the chiller 15 and evaporator 14 is temporarily prevented.

The bypass valve 31 can likewise be controlled in such a way that it is partially or completely opened while the main circuit 24 is in operation. At the same time, the evaporator valve 20 and the chiller valve 21 are closed. Heat dissipation is thus prevented both at the evaporator 14 and at the chiller 15.

Apart from the bypass valve 31 and the bypass line 30, refrigeration circuit 110 corresponds to the refrigeration circuit 10 according to the first exemplary embodiment, and therefore reference is made to the description thereof.

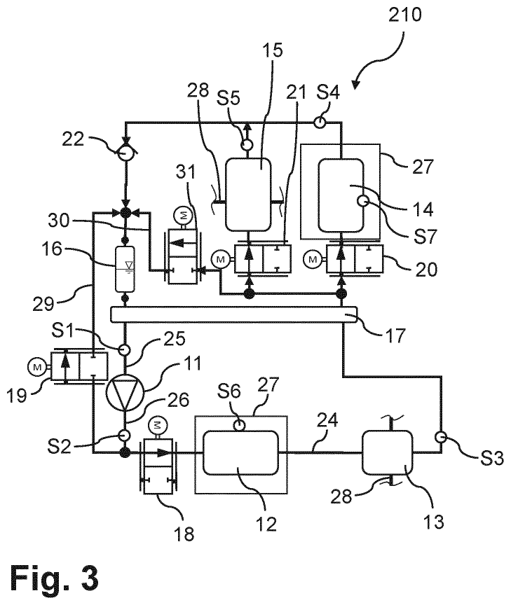

FIG. 3 schematically shows a refrigeration circuit 210 according to a third exemplary embodiment of the present disclosure. Refrigeration circuit 210 differs from refrigeration circuit 110 only in that check valve 23 is omitted. That is, a series circuit comprising the evaporator valve 20 and the evaporator 14 is parallel to a series circuit comprising the chiller valve 21 and the chiller 15. Check valve 22 is arranged downstream of these parallel series circuits. The bypass line 30 is in turn arranged parallel to the circuit comprising the evaporator valve 20, the evaporator 14, the chiller valve 21, the chiller 15 and check valve 22. This has the advantage that one check valve can be omitted.

Apart from this common check valve 22, refrigeration circuit 210 corresponds to the refrigeration circuit 110 according to the second exemplary embodiment, and therefore reference is made to the description thereof.

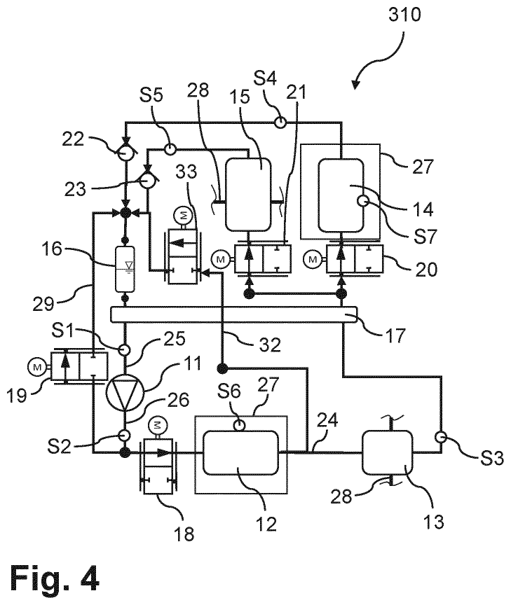

FIG. 4 schematically shows a refrigeration circuit 310 according to a fourth exemplary embodiment of the present disclosure. Refrigeration circuit 310 differs from refrigeration circuit 10 only in that a bypass line 32 is provided in parallel with the series circuit comprising the condenser 13 and the parallel circuit comprising the evaporator 14 and the chiller 15, which bypass line branches off from the main circuit 24 between the heating condenser 12 and the condenser 13 and leads back into the main circuit 24 between the check valves 22, 23 and the liquid collector 16. Arranged in the bypass line 32 is a bypass valve 33, which is designed to block or release throughflow, in particular to block, partially release or completely release it.

In an operating state in which the bypass line 32 is released by controlling the bypass valve 33 and, at the same time, the evaporator valve 20 and the chiller valve 21 are closed, the refrigerant flow does not flow through the condenser 13, the evaporator 14 and the chiller 15, and therefore heat dissipation from the refrigeration circuit 310 via this component is prevented. Despite the emission of heat at the heating condenser 12, this leads to a faster start-up behavior of the refrigeration circuit 310. Thus, in parallel with the operation of the short circuit, heating of the vehicle occupant compartment can already take place via the heating condenser 12.

As an option, the evaporator valve 20 and/or the chiller valve 21 can be partially or completely opened, with the result that heat emission at the components through which the flow passes is not completely but only partially prevented.

Apart from the bypass line 32 and the sixth valve 33, refrigeration circuit 310 corresponds to the refrigeration circuit 10 according to the first exemplary embodiment, and therefore reference is made to the description thereof.

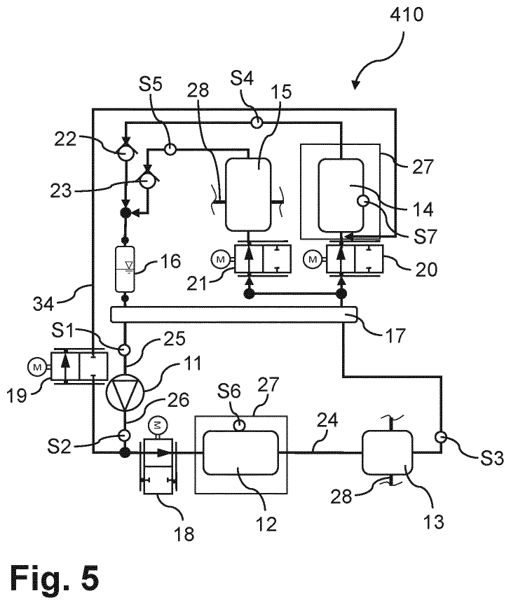

FIG. 5 schematically shows a refrigeration circuit 410 according to a fifth exemplary embodiment of the present disclosure. Refrigeration circuit 410 differs from refrigeration circuit 10 only in that return line 34 leads into the main circuit 24 at a different location compared to return line 29. Thus, return line 34 leads back into the main circuit 24 upstream of the evaporator 14, more precisely between the evaporator valve 20 and the evaporator 14. Apart from this changed lead-in, the description of return line 29 applies to return line 34.

Apart from the lead-in of return line 34, refrigeration circuit 410 corresponds to the refrigeration circuit 10 according to the first exemplary embodiment, and therefore reference is made to the description thereof.

This exemplary embodiment has the advantage that a bypass valve as in the second, third and fourth exemplary embodiments becomes superfluous as a result.

It is furthermore possible, in this exemplary embodiment, to provide an operating state in which an air flow at the evaporator 14 on the air conditioner side is blocked, ensuring that heat dissipation at the evaporator 14 is temporarily prevented.

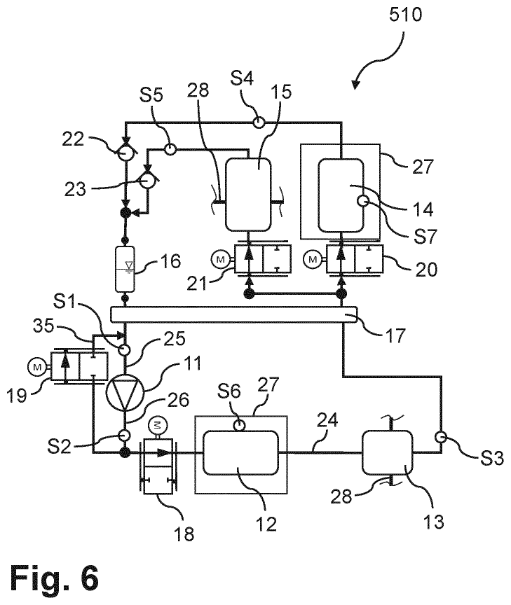

FIG. 6 schematically shows a refrigeration circuit 510 according to a sixth exemplary embodiment of the present disclosure. Refrigeration circuit 510 differs from refrigeration circuit 10 only in that return line 35 leads into the main circuit 24 at a different location compared to return line 29. Thus, return line 35 leads back into the main circuit 24 on the inlet side of the refrigerant compressor 11, more precisely between the inner heat exchanger 17 and the refrigerant compressor 11.

Apart from this changed lead-in, the description of return line 29 applies to return line 35.

Apart from the lead-in of return line 35, refrigeration circuit 510 corresponds to the refrigeration circuit 10 according to the first exemplary embodiment, and therefore reference is made to the description thereof.

This exemplary embodiment has the advantage that the inner heat exchanger 17 is bypassed owing to the changed lead-in in the short circuit, as a result of which heat discharge via the inner heat exchanger 17 is avoided.

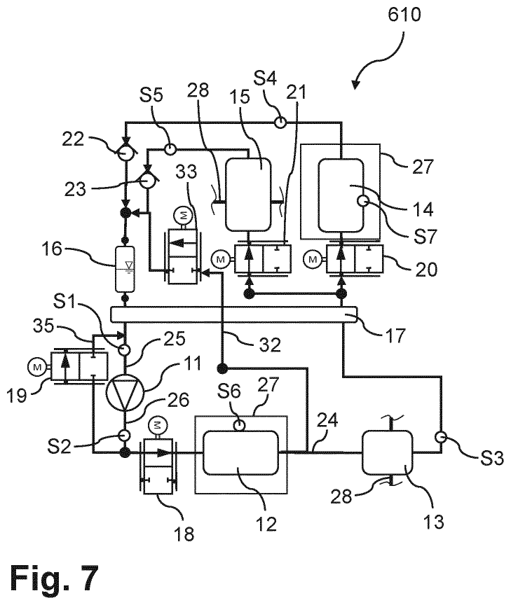

FIG. 7 schematically shows a refrigeration circuit 610 according to a seventh exemplary embodiment of the present disclosure. Refrigeration circuit 610 differs from refrigeration circuit 310 only in that return line 35 leads into the main circuit 24 at a different location compared to return line 29. Thus, return line 35 leads back into the main circuit 24 on the inlet side of the refrigerant compressor 11, more precisely between the inner heat exchanger 17 and the refrigerant compressor 11.

Apart from this changed lead-in, the description of return line 29 applies to return line 35.

Apart from the lead-in of return line 35, refrigeration circuit 610 corresponds to the refrigeration circuit 310 according to the fourth exemplary embodiment, and therefore reference is made to the description thereof.

This exemplary embodiment likewise has the advantage that the inner heat exchanger 17 is bypassed owing to the changed lead-in in the short circuit, as a result of which heat discharge via the inner heat exchanger 17 is avoided.

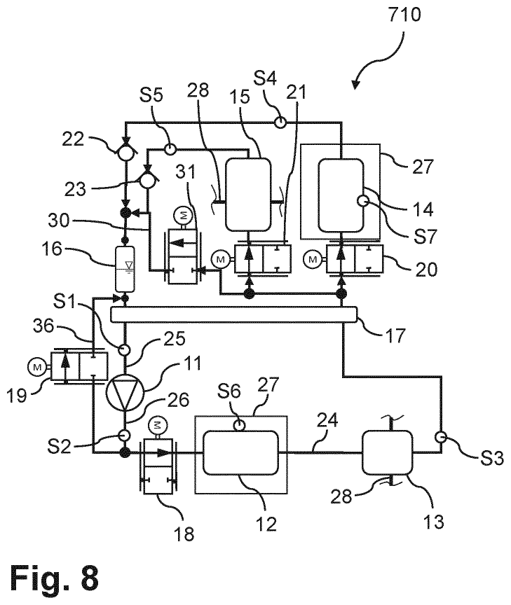

FIG. 8 schematically shows a refrigeration circuit 710 according to an eighth exemplary embodiment of the present disclosure. Refrigeration circuit 710 differs from refrigeration circuit 110 only in that return line 36 leads into the main circuit 24 at a different location compared to return line 29. Thus, return line 36 leads back into the main circuit 24 between the liquid collector 16 and the inner heat exchanger 17, upstream of the refrigerant compressor 11. Apart from this changed lead-in, the description of return line 29 applies to return line 36.

Apart from the lead-in of return line 36, refrigeration circuit 710 corresponds to the refrigeration circuit 110 according to the second exemplary embodiment, and therefore reference is made to the description thereof.

This exemplary embodiment has the advantage that heat exchange via the inner heat exchanger 17 is possible in the short circuit. The refrigerant compressor is protected from liquid refrigerant by the inner heat exchanger.

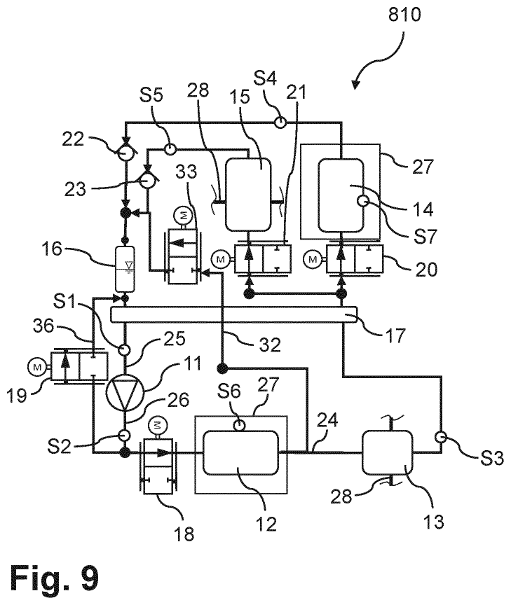

FIG. 9 schematically shows a refrigeration circuit 810 according to a ninth exemplary embodiment of the present disclosure. Refrigeration circuit 810 differs from refrigeration circuit 310 only in that return line 36 leads into the main circuit 24 at a different location compared to return line 29. Thus, return line 36 leads back into the main circuit 24 between the liquid collector 16 and the inner heat exchanger 17, upstream of the refrigerant compressor 11. Apart from this changed lead-in, the description of return line 29 applies to return line 36.

Apart from the lead-in of return line 36, refrigeration circuit 810 corresponds to the refrigeration circuit 310 according to the fourth exemplary embodiment, and therefore reference is made to the description thereof.

This exemplary embodiment likewise has the advantage that heat exchange via the inner heat exchanger 17 is possible in the short circuit.

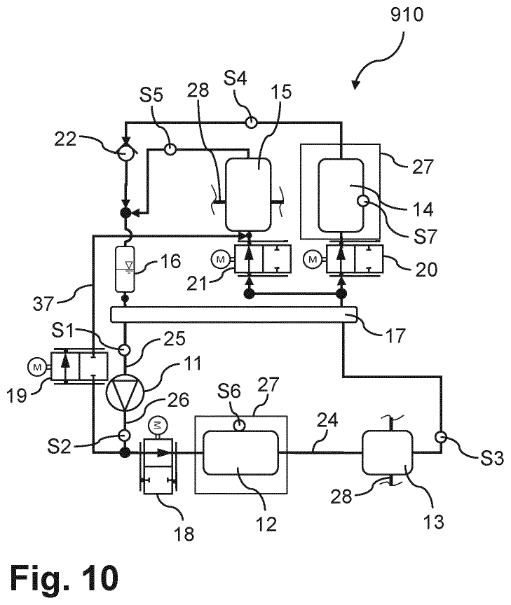

FIG. 10 schematically shows a refrigeration circuit 910 according to a tenth exemplary embodiment of the present disclosure. Refrigeration circuit 910 differs from refrigeration circuit 10 only in that return line 37 leads into the main circuit 24 at a different location compared to return line 29. Thus, return line 37 leads back into the main circuit 24 upstream of the chiller 15, more precisely between the chiller valve 21 and the chiller 15. Apart from the changed lead-in, the description of return line 29 applies to return line 37. Moreover, check valve 23 is omitted from the refrigeration circuit 10 downstream of the chiller 15.

Apart from these two differences, refrigeration circuit 910 corresponds to the refrigeration circuit 10 according to the first exemplary embodiment, and therefore reference is made to the description thereof.

In this case, the chiller 15 serves, by virtue of its deflections, as a mixing chamber for mixing liquid refrigerant components (coming from the main circuit 24) with gaseous refrigerant components (coming from return line 37). While the invention has been illustrated and described in detail in the drawings and the preceding description, this illustration and description is to be understood as exemplary and not as limiting, and there is no intention to limit the invention to the disclosed exemplary embodiments. The mere fact that certain features are mentioned in various dependent claims is not intended to imply that a combination of these features could not also be used to advantage.

1-14. (canceled)

15. A refrigeration circuit for a motor vehicle comprising:
a refrigerant compressor;
a condenser configured to exchange heat with a cooling circuit;
a chiller configured to exchange heat with the cooling circuit;
an evaporator configured to control a temperature of air in an air-conditioning device, wherein the evaporator is arranged in parallel with the chiller, wherein the refrigerant compressor, the condenser and the parallel circuit comprising the chiller and the evaporator are connected in series in a main circuit;
a return line that branches off from the main circuit on a high-pressure side of the refrigerant compressor and leads into the main circuit on a low-pressure side of the refrigerant compressor; and
a valve circuit configured to block and release flow through the return line.

16. The refrigeration circuit according to claim 15, comprising:
a heating condenser configured to control the temperature of air in the air-conditioning device, wherein the refrigerant compressor, the heating condenser, the condenser, and the parallel circuit comprising the chiller and the evaporator are connected in series in the main circuit.

17. The refrigeration circuit according to claim 15, wherein the valve circuit is configured to block and release flow through the main circuit.

18. The refrigeration circuit according to claim 15, wherein
the valve circuit comprises a valve arranged at the branch of the return line from the main circuit.

19. The refrigeration circuit according to claim 15, wherein
the valve circuit comprises:
a first valve arranged in the main circuit, downstream of the branch of the return line from the main circuit, and is configured to block and release flow through the main circuit; and
a second valve arranged in the return line and configure to block and release flow through the return line.

20. The refrigeration circuit according to claim 15, comprising:
a chiller valve arranged upstream of the chiller and configured to block and release throughflow.

21. The refrigeration circuit according to claim 15, comprising:
an evaporator valve arranged upstream of the evaporator and configured to block and release throughflow.

22. The refrigeration circuit according to claim 15, comprising:
an inner heat exchanger that connects the high-pressure side of the refrigerant compressor to the low-pressure side of the refrigerant compressor in a manner which transfers heat and is fluidically separate.

23. The refrigeration circuit according to claim 15, comprising:
a bypass line comprising a bypass valve, which bypass line connects the high-pressure side of the refrigerant compressor to the low-pressure side of the refrigerant compressor and bypasses at least the chiller and the evaporator, wherein the bypass valve is configured to block and release throughflow.

24. A heat management system comprising:
the refrigeration circuit according to claim 15;
the cooling circuit; and
the air-conditioning device.

25. A motor vehicle comprising the heat management system according to claim 24.

26. A motor vehicle comprising the refrigeration circuit according to claim 15.

27. A method for controlling a refrigeration circuit, the refrigeration circuit comprising:
a refrigerant compressor;
a condenser configured to exchange heat with a cooling circuit;
a chiller configured to exchange heat with the cooling circuit;
an evaporator configured to control a temperature of air in an air-conditioning device, wherein the evaporator is arranged in parallel with the chiller, wherein the refrigerant compressor, the condenser and the parallel circuit comprising the chiller and the evaporator are connected in series in a main circuit;
a return line that branches off from the main circuit on a high-pressure side of the refrigerant compressor and leads into the main circuit on a low-pressure side of the refrigerant compressor; and
a valve circuit configured to block and release flow through the return line;
the method comprising:
operating the refrigeration circuit in an operating state in which the valve circuit blocks flow through the main circuit and releases flow through the return line, thus preventing heat dissipation from the refrigeration circuit via a heating condenser and the condenser.

28. A method for controlling a refrigeration circuit, the refrigeration circuit comprising:
a refrigerant compressor;
a condenser configured to exchange heat with a cooling circuit;
a chiller configured to exchange heat with the cooling circuit;
an evaporator configured to control a temperature of air in an air-conditioning device, wherein the evaporator is arranged in parallel with the chiller, wherein the refrigerant compressor, the condenser and the parallel circuit comprising the chiller and the evaporator are connected in series in a main circuit;
a return line that branches off from the main circuit on a high-pressure side of the refrigerant compressor and leads into the main circuit on a low-pressure side of the refrigerant compressor; and
a valve circuit configured to block and release flow through the return line;
the method comprising:
operating the refrigeration circuit in an operating state in which the valve circuit releases flow through the main circuit and releases flow through the return line.

29. The method according to claim 28, further comprising:
setting the flow through the main circuit via the valve circuit in accordance with a heating power requirement in a vehicle occupant compartment.

30. The method according to claim 28, wherein the refrigeration circuit also comprises a chiller valve arranged upstream of the chiller and an evaporator valve arranged upstream of the evaporator, which are designed to block and release throughflow,
the method further comprising operating the refrigeration circuit in an operating state in which a pressure level on the low-pressure side of the refrigerant compressor is set in such a way via control of the valve circuit, the evaporator valve, the chiller valve, and the refrigerant compressor, that the refrigerant compressor is operated at its continuous power maximum.
